(19) United States
(12) Patent Application Publication
(10) Pub. No.: US 2020/0112283 A1
(43) Pub. Date: Apr. 9, 2020

(54) ELECTRICAL IMPACT WRENCH WITH REBOUND IMPACT MECHANISM

(71) Applicant: ETABLISSEMENTS GEORGES RENAULT, Saint Herblain (FR)

(72) Inventor: Pierre Mahot, La Montagne (FR)

(21) Appl. No.: 16/593,621

(22) Filed: Oct. 4, 2019

(30) Foreign Application Priority Data
Oct. 5, 2018 (FR) 1859247

(51) Int. Cl. H02P 29/40; B25B 21/02; B25B 23/147

(52) U.S. Cl. CPC H02P 29/40; B25B 23/1475; B25B 21/02

(57) ABSTRACT

An impact wrench includes: an electric motor having a rotor and a stator; a rebound type impact mechanism; a power supply controller configured to control the power supply of the motor and regulate the supply current of the motor. The rotor of the motor is directly connected to the impact mechanism. The power supply controller of the motor is configured to deliver, to the current regulator, during a screw driving operation, a setpoint value of supply current for the motor inducing the generation, by the motor, of a predetermined electromagnetic torque.

### 1. FIELD OF THE INVENTION

The field of the invention is that of the designing and manufacture of impact wrenches.

### 2. PRIOR ART

Impact wrenches are commonly used in diverse fields, especially in motor vehicle garages and for industrial maintenance.

These tools are mainly used for the dismantling of mechanical components on vehicles or on machines. They can also be used for mounting and remounting certain components.

The components, which are tightened or loosened by the use of impact wrenches, are clean and/or oxidized in varying degrees.

In addition, the spaces of action can be confined, difficult to access and encumbered by other potentially injurious and poorly-lit components.

Impact wrench users therefore expect their tools to help limit the effects of the difficulties mentioned here above.

Thus, in order to reduce the difficulties related to using impact wrenches in confined and encumbered spaces, users wish to use compact tools.

More generally, the impact wrench users have expectations especially in terms of ergonomy, efficiency and durability.

In terms of ergonomy, the users wish for noiseless and low-weight tools that entail only a low level of vibration for the user.

In terms of efficiency, the users wish to be able to rapidly carry out tightening/loosening operations with an appropriate level of quality (tightening to the desired torque value) while benefiting from high visibility of the zone of intervention.

The users further wish to have independent tools not constrained by an electrical power cable or a compressed-air supply tube.

In terms of durability, users wish to have solid tools that are especially shock-resistant and capable of working well over time.

There are different types of known impact wrenches, especially:

pneumatic impact wrenches with rebound impact mechanism;

electric impact wrenches with non-rebound impact mechanism;

electric impact wrenches with rebound impact mechanism;

electrical wrenches with impact generation by AC supply;

Impact wrenches with rebound impact mechanism comprise an impact mechanism which, at each impact, induces a rebound of the rotor of the motor in reverse to the working direction or direction of the operation (the screwing or unscrewing direction).

The working direction corresponds to the clockwise direction when screwing a screw with right-handed thread or to an anticlockwise direction when unscrewing a screw with a right-handed thread.

The working direction corresponds to the anticlockwise direction in the case of screwing with a screw having a left-handed thread or to the clockwise direction in the case of unscrewing a screw with a left-handed thread.

These wrenches with rebound impact mechanism include especially:

Maurer type twin-hammer, twin-lobe or double-dog impact mechanisms;

Single-dog mechanisms;

Rocking-dog mechanisms;

two-jaw mechanisms;

pin-clutch mechanisms;

etc.

According to a different approach, impact wrenches with non-rebound impact mechanisms comprise, between their motor and the impact mechanism, a kinematic chain incorporating an elastic element capable of being deformed to enable the rotor of the motor to continue to rotate when, at each impact, the rotation of the output shaft of the impact wrench is greatly accelerated by the element during tightening. The kinetic energy accumulated by the rotor at the end of each impact is restored at the next impact in the form of potential energy to transmit a torque to the output shaft of the impact wrench.

Pneumatic Impact Wrenches with Rebound Impact Mechanism

The U.S. Pat. Nos. 3,661,217 and 4,287,956 describe examples of pneumatic impact wrenches with Maurer type rebound impact mechanisms.

These impact wrenches comprise a pneumatic motor provided with a rotor and a stator, an impact mechanism driven by the rotor of the motor and an output square drive that can cooperate with a component to be tightened/loosened.

The impact mechanism comprises a cage rotationally driven by the rotor within which there are fixed two rotationally mobile hammers capable of colliding with the square drive carrying two anvils to generate impacts.

To carry out a screwing/unscrewing operation, the motor is fed continuously with compressed air under constant pressure, thus driving the cage rotationally. During the rotation of the cage, the hammers come into collision with the anvils. At each collision of the hammers against the anvils, the striking mechanism transmits, in an impact, a torque to the square drive that rotationally drives the element to be screwed/unscrewed.

At each impact in the impact mechanism, the kinematic chain between the motor and the square drive gets deformed and thus accumulates potential energy. This potential energy is restored during the relaxation of the kinematic chain, inducing a rebound of the impact mechanism in reverse to the working direction, i.e. in reverse to the direction of the screwing/unscrewing operation.

During this rebound, the hammers take a disengaged position in which the hammers are no longer facing anvils. The hammers keep this position momentarily during the re-acceleration of the rotor in the direction of the operation. Thus, the hammers go past the anvils without striking them, thus enabling the cage to accelerate in its rotational motion. After a given rotation of the cage (a rotation of the order of one turn in the configuration illustrated), the hammers again collide with the anvils to transmit the kinetic energy of the moving parts to the square drive.

The cycles are thus repeated to carry out the screwing/unscrewing operation to its end.

Such a principle of operation is described for example in detail in U.S. Pat. No. 3,661,217.

This is therefore a rebounding impact mechanism of the type with automatic disengagement of the hammers from the anvil during the rebound and at the beginning of the re-acceleration followed by an automatic re-engagement.

Such an impact mechanism provides improved balancing of the assembly. It also reduces vibrations as compared with a single-hammer mechanism or what is called a rocking-dog type mechanism.

Such an impact mechanism is compact, i.e. it has a length and a diameter smaller than the length and diameter of the other impact mechanisms. This mechanism thus enjoys the best weight/power ratio of known impact mechanisms.

Such an impact mechanism is also reputed to have high lasting quality.

The drawback of such an impact mechanism is that it is only appropriated for pneumatic tools.

Indeed, we have seen that, after each impact, the impact mechanism rebounds. However, the motor is supplied with constant air pressure so much so that, leaving aside the motor efficiency, the torque that it delivers is constant. Thus if, during a rebound, the torque delivered by the motor is smaller than the torque due to the rebound, the motor slows down, stops or runs in reverse.

While such a type of operation is well supported by a pneumatic motor and shows no deterioration, an electric motor supports it badly, and there is rapid deterioration. Indeed, a brush motor will have its brushes deteriorate if it is frequently made to work in both directions, whereas a speed-regulated, permanent-magnet synchronous motor will be subject to excess currents.

Electrical Impact Wrenches with Non-Rebound Impact Mechanism

The patent applications US-A1-2016/250738 and US-A1-2016/121467 describe two examples of electrical impact wrenches with a non-rebound impact mechanism.

Electrical impact wrenches with a non-rebound impact mechanism comprise an impact mechanism that does not, at each impact, induce any rebound of the rotor of the motor in reverse to the working direction (screwing or unscrewing direction).

These non-rebound impact mechanisms are better known as “spring loading cams”.

An example of a mechanism of this type is illustrated in FIGS. 12, 13, 14 and 15.

Referring to these figures, such a mechanism comprises a shaft 80 rotationally linked with a planet carrier 81 carrying planet gears 82 that engaged on the one hand with an annulus or ring 83 mounted so as to be fixed in the casing of the impact wrench and, on the other hand, with a sun gear (not shown) rotationally linked with the shaft of the motor (not shown) of the impact wrench.

The shaft 80 has helical grooves 84 each housing a ball 85.

The mechanism comprises a cage 86 mounted so as to be rotationally mobile in rotation and in translation relative to the shaft 80 against the effect of a compression spring 91. As shall be described in greater detail here below, the cage 86 can thus move to take an engaged position (FIGS. 12 and 13) and a released position (FIGS. 14 and 15).

The cage 86 comprises grooves 87 housing the balls 85. It also comprises hammers 88.

The mechanism comprises an anvil 89 mounted so as to be mobile in rotation at the extremity of the shaft 80 and linked in rotation with the square drive 90 which can cooperate with a component to be screwed/unscrewed.

During a screwing/unscrewing operation, impact cycles succeed one another until a target tightening torque is obtained.

At each impact cycle, the cage 86 is rotationally driven in the screwing direction to accumulate kinetic energy which it restores to the element to be screwed in the form of a torque during the collision of its hammers 88 with the anvil 89.

To this end, the electrical motor is permanently powered so that the rotor rotationally drives the shaft 80 by means of an epicyclic train.

The screwing of a screw classically takes place in two steps:
the pre-screwing, during which the head of the screw is not in contact with the part to be fixed, so much so that the screw does not put up any opposing resistant torque, and
the screwing, which takes place between the moment when the head of the screw comes into contact with the assembly and the moment when the target torque is attained, and during which the screw puts up an opposing resistant torque.

During the pre-screwing step, the compression spring 91 keeps the cage 86 in an engaged position and the mechanism rotates as one piece driving the screw until its head comes into contact with the part to be fixed.

At this stage, the screwing step starts and the screw begins to put up an opposing resistant torque, the rotation of the cage 86 being stopped by the anvils carried by the output shaft.

The shaft 80 driven by the motor via the epicyclic train continues to rotate and because of the helical grooves 84 and the balls 85, the cage moves in translation towards the motor, thus compressing the spring, to attain the released position.

During this translation motion, the anvils 88 carried by the cage 86 get disengaged from the anvils 89. When the disengagement is complete, the cage 86 can rotate in sliding on the anvils 89 and, then when the hammers 88 have gone beyond the anvils 89, the cage 86 moves towards the output shaft under the effect of the thrust of the spring 91.

The movement of the cage 8 then follows the trajectory permitted by the helical grooves 84 and the balls 85 in making the cage 86 acquire a kinetic energy of rotation that is transferred to the output shaft and to the screw when, at the end of the trajectory of the cage 88, the hammers strike the anvils 89.

The impact cycles succeed one another until the user considers the screwing to be sufficient.

This “non-rebound” impact mechanism prevents the rebound at each impact of the rotor of the motor, and thus prevents the motor from being stopped or driven in reverse to the operation in progress. The motor can thus operate in a stabilized mode, thus making this type of impact mechanism quite particularly compatible with the electric motors which require stabilized functioning so as to not to undergo any premature breakage or ageing.

Impact wrenches of this type also have the advantage of being portable and particularly easy to handle especially when they are powered by an embedded battery.

An impact mechanism of this type has the drawback of needing sufficient torque to compress the spring. It is therefore important for its efficient operation that the motor should be coupled to the cage via a reduction gear, generally of the epicyclic train type.

The use of a reduction gear as well as the use of the spring in this mechanism gives rise to:

an increase in the mass of the tool (reduction);

an increase in length (reduction+spring).

Given the fact that the operation of such a mechanism induces the oscillatory shift in translation of the cage in the direction of the axis of the motor, such a mechanism induces longitudinal vibrations perceived by the user.

From this viewpoint, the Maurer mechanism described here above does not have this drawback.

Electric Impact Wrenches with a Rebound Impact Mechanism

Electrical impact wrenches with rebound impact mechanism comprise, like pneumatic impact wrenches with rebound impact mechanism, an impact mechanism which, at each impact, induces a rebound of the rotor of the motor in reverse to the working direction (the screwing or unscrewing direction).

Electrical impact wrenches with rebound impact mechanism have the advantages of pneumatic impact wrenches and electrical impact wrenches with non-rebound impact mechanism without having their drawbacks:
the compactness and lightness of rebound impact mechanisms, in particular those of the Maurer mechanism;
the absence of longitudinal vibration of a rebound impact mechanism;
the freedom of use of a battery-operated tool.

The U.S. Pat. No. 7,607,492 describes an impact wrench of this type comprising an electric motor directly driving a Maurer type impact mechanism.

As has been explained further above, a rebound type impact mechanism induces a rebound of the rotor of the motor. This means that it cannot be implemented compatibly with an electrical motor without undergoing rapid deterioration.

Indeed, electric motors are conventionally speed-regulated.

The control means of the motor comprise means of regulation which, on the basis of a setpoint value, regulate the operation of the motor in such a way as to maintain the speed of the motor as close as possible to the predetermined setpoint value of speed.

During a rebound of the impact mechanism, the rotor of the motor rotates in reverse to the direction in which it is powered. However, to try and maintain the rotation speed of the motor at a value close to the setpoint speed, the regulation system of the motor could greatly increase the supply current beyond the level that this system can support.

The Maurer type mechanism is a rebound mechanism that therefore causes very great variations of speed contrary to a non-rebound mechanism of the “spring loaded cam” type which, for its part, shows low variations in motor speed, thus making the former unsuited to implementation within an electric tool.

The U.S. Pat. No. 7,607,492 however describes a solution to limit this problem.

This solution consists in monitoring the rebound of the impact mechanism by monitoring the direction of rotation of the impact mechanism and, each time that a rebound is detected, cutting off the power supply in the direction of the screwing/unscrewing operation in progress or powering on the motor in the rebound direction to control the rebound angle and thus reduce pressure on the system. The drawbacks that result from this type of motor control are the following:
the electromagnetic torque delivered by the motor is in constant variation and this increases the sensation of vibration felt by the user;
the complexity of controlling the motor makes it necessary to observe the direction of rotation of the motor in real time to detect the rebound by using an optical sensor which is fragile;
the use of an energy restoring mechanism, the durability of which may prove to be short (such a mechanism indeed implements a freewheel and a spring which, by nature, are relatively fragile components);
the performance level is lower than that of a tool provided with a pneumatic motor given that the power supply to the motor is not permanent throughout a screwing/unscrewing operation.

Electric Impact Wrench with Impact Generation by Alternating Power Supply

The patent application FR-A1-2 974 320 describes a wrench with impact generation by alternating power supply.

Impact wrenches of this type have the classic architecture of a screwdriver known as a continuous-tightening screwdriver, i.e. a classic screwdriver that can be used to tighten a screw without generating any impact through continuous power supply to the motor during the screwing operation.

These impact wrenches therefore do not integrate any impact mechanism of the type described here above.

According to a different approach, these impact wrenches make use of the play in the transmission to generate impacts resulting from a power supply to the motor by electric current pulses. This principle is described in detail in the document described further above.

Thus a screwdriver of this type, which is not powered by electric current pulses, would not enable impact screwing but continuous screwing.

The patent document WO-A1-2011/102559 describes another type of electric impact wrench with impact generation by alternating power supply. During the use of this impact wrench, the motor is powered periodically in reverse to the direction of the operation in progress so as to bring the hammer back to a recoil position in which it is at a distance from the anvil. It is then accelerated to put the hammer and the anvil into contact and then to lead to a rotation of the output shaft.

Thus, a screwdriver of this type, which is not powered by electrical current pulses, would be able to carry out not an impact screwing operation but a continuous screwing operation. This is because, unlike rebound impact mechanisms of the type using automatic disengagement followed by automatic re-engagement, the hammers do not disengage the anvils during rebound and re-acceleration. Indeed, in the context of the use of a screwdriver of this type with continuous power supply (and not pulsed power supply), the parts of the transmission chain remain in contact with one another after the first impact so much so that the screwdriver behaves like a continuous-tightening screwdriver.

### Conclusion on the Prior Art

In the end, the non-rebound impact mechanism driven by an electric motor is heavy and bulky. In addition, the axial shifts of the bell cause the tool to vibrate greatly.

The use of a Maurer type rebound impact mechanism, directly driven within an electric tool with a break in the power supply of the motor during impacts, necessitates a complex mechanical architecture and regulation. In addition, the variations in current produce variations in the electromotive torque and therefore variations in the reaction torque in the grip. These variations in torque are perceived as vibrations of the tool by the user.

There is therefore an opportunity to improve electric impact wrenches with rebound impact mechanisms.

An exemplary embodiment of the present disclosure relates specifically to the field of electric impact wrenches with rebound impact mechanisms which it proposes to improve.

### 3. SUMMARY

An illustrative embodiment of the disclosure relates to an impact wrench comprising:

an electric motor comprising a rotor and a stator;

a rebound type impact mechanism;

means to control the power supply of said motor comprising means to regulate the power supply current of said motor;

said rotor of said motor being directly connected to said impact mechanism.

According to an exemplary embodiment, said means for controlling the power supply of said motor are configured to deliver, to said regulation means, during a screwing or unscrewing operation, a setpoint value of supply current for said motor inducing the generation, by said motor, of a predetermined electromagnetic torque.

Thus, an exemplary embodiment relies on the implementation of an electric impact wrench with rebound impact mechanism, the motor of which is regulated in terms of torque, or more particularly in terms of current, and no longer in terms of speed.

The fact of regulating the motor in terms of torque (in terms of current) and no longer in terms of speed prevents a situation where, during the rebound of the rebound mechanism, the regulation of the motor tends to maintain its constant speed by increasing its power supply voltage with the risk of the system getting blocked by getting placed in a safety mode when the supply current surpasses an acceptable boundary threshold.

According to one possible characteristic, said setpoint value of power supply current inducing the generation, by said motor, of an electromagnetic torque is predetermined as a function of time.

According to one possible characteristic, said setpoint value of a supply current is configured to induce an evolution of said predetermined electromagnetic torque according to one or more combinations of several of the following laws:
electromagnetic torque varying increasingly or decreasingly according to a predetermined linear or polynomial or exponential function according to time throughout said screwing or unscrewing operation,
electromagnetic torque that is constant throughout said screwing or unscrewing operation,
said screwing or unscrewing operation comprises at least two phases of predetermined durations, said setpoint value of power supply current being configured so that no electromagnetic torque is delivered by said motor between said at least two phases, this being the case for a predetermined duration, and configured to induce an evolution of said predetermined electromagnetic torque according to one of the above laws during said phases.

According to one possible characteristic, said means for controlling the power supply of said motor are configured to supply said motor in the working direction including during the rebound of the rebound impact mechanism.

In the context of a screwing operation comprising at least one interruption of current supply, it is possible that the kinetic energy accumulated by the rotor generates an impact and therefore a rebound without power. The maintenance of the power supply during the rebound mentioned further above does not concern this type of rebound without power since, by definition, it would occur at an instant at which the power supply is cut off.

According to one possible characteristic, said means for controlling the power supply of said motor comprise means for determining said setpoint value of supply current in real time.

According to one possible characteristic, the impact wrench comprises a starting trigger and the means for determining said setpoint value of supply current in real time comprise means for measuring the time elapsed since said starting trigger has been pressed.

According to one possible characteristic, an impact wrench according to an exemplary embodiment comprises means of selection, by the user, of:

the working direction of the impact wrench in screwing or unscrewing;

the law;

the power level.

According to one possible characteristic, said means for determining the supply current in real time use:

a measurement of the time elapsed since the trigger has been pressed;

the type of work selected by the user, screwing or unscrewing;

the law selected by the user;

the power level selected by the user.

An exemplary embodiment also relates to a method of screwing/unscrewing by means of an impact wrench with electric motor according to any one of the above variants comprising a step of screwing or unscrewing, said step of screwing or unscrewing comprising the delivery, to said means of regulation, of an setpoint value of supply current inducing the generation by said motor of a predetermined electromagnetic torque.

According to one particular characteristic, said setpoint value of supply current inducing the generation by said motor of an electromagnetic torque is predetermined as a function of time.

According to one possible characteristic, said setpoint value of supply current is configured to induce an evolution of said predetermined electromagnetic torque according to one or a combination of several of the following laws:
electromagnetic torque varying increasingly or decreasingly according to a predetermined linear or polynomial or exponential function according to time throughout said screwing or unscrewing operation,
electromagnetic torque constant throughout said screwing or unscrewing operation,
said screwing or unscrewing operation comprises at least two phases of predetermined durations, said setpoint value of supply current being configured so that no electromagnetic torque is delivered by said motor between said at least two phases, for a predetermined duration, and configured to induce an evolution of said predetermined electromagnetic torque according to one of the preceding laws, during said phases.

According to one possible characteristic, said motor is powered in the working direction, including during the rebound of the rebound impact mechanism.

According to one possible characteristic, a method according to an exemplary embodiment comprises determining said setpoint value of supply current in real time.

According to one possible characteristic, a method according to an exemplary embodiment comprises measuring the time elapsed since the starting trigger of said impact wrench has been pressed.

According to one possible characteristic, a method according to an exemplary embodiment comprises selection by the user of:

the working direction of the impact wrench in screwing or unscrewing;

the law;

the power level.

According to one possible characteristic, a method according to an exemplary embodiment comprises determining said setpoint value of supply current in real time in taking account of:

the measurement of the time elapsed since the trigger has been pressed;

the type of work selected by the user, screwing or unscrewing;

the law selected by the user;

the power level selected by the user.

### 4. LIST OF FIGURES

Other features and advantages shall appear from the following description of particular embodiments, given by way of a simple, illustratory and non-exhaustive example, and from the appended figures of which:

FIG. 1 illustrates a cross-section view of an impact wrench according to an exemplary embodiment;

FIG. 2 is an exploded view of an example of an impact mechanism that can be integrated into an impact wrench according to an exemplary embodiment;

FIG. 3 illustrates a view in section along the plane A-A of the impact mechanism of the impact wrench of FIG. 1;

FIG. 4 is a schematic representation of an example of control means according to an exemplary embodiment;

FIG. 5 illustrates an example of a vector command of an electric motor;

FIG. 6 is a flowchart illustrating different phases of a method according to an exemplary embodiment;

FIGS. 7, 8, 9, 10 and 11 illustrate the variation in time of the torque impacts delivered by the impact wrench and the setpoint value of supply current of the motor during a screwing operation according to three strategies consisting respectively in:
varying the electromagnetic torque increasingly according to a predetermined linear function according to time throughout the screwing operation;
varying the electromagnetic torque increasingly according to a predetermined polynomial function according to time throughout the screwing operation;
varying the electromagnetic torque decreasingly according to a predetermined linear function according to time throughout the unscrewing operation;
keeping the electromagnetic torque constant throughout said screwing or unscrewing operation;
when the screwing or unscrewing operation comprises at least two phases of predetermined duration, delivering no electromagnetic torque between the phases and making the electromagnetic torque evolve according to one of the above laws during the phases.

FIGS. 12 to 15 illustrate an example of a non-rebound impact mechanism according to the prior art;

FIGS. 16 to 26 illustrate the variation in time of the torque impacts delivered by the impact wrench and of the setpoint value of supply current of the motor during a screwing operation according to other principles.

### 5. DESCRIPTION OF PARTICULAR EMBODIMENTS

5.1. Architecture

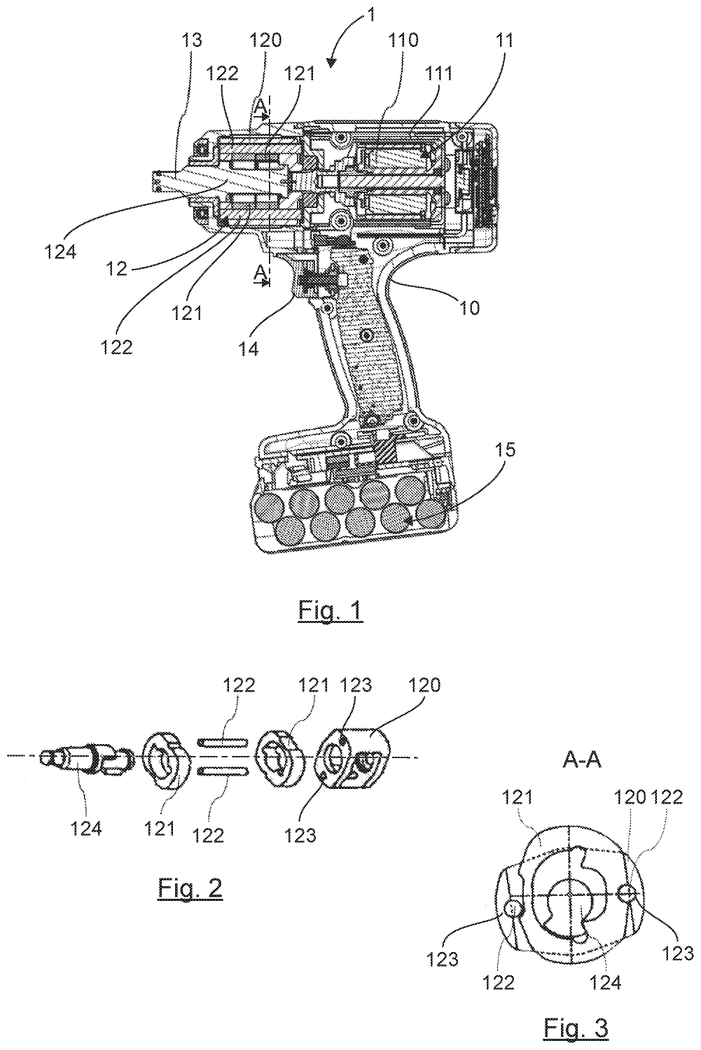

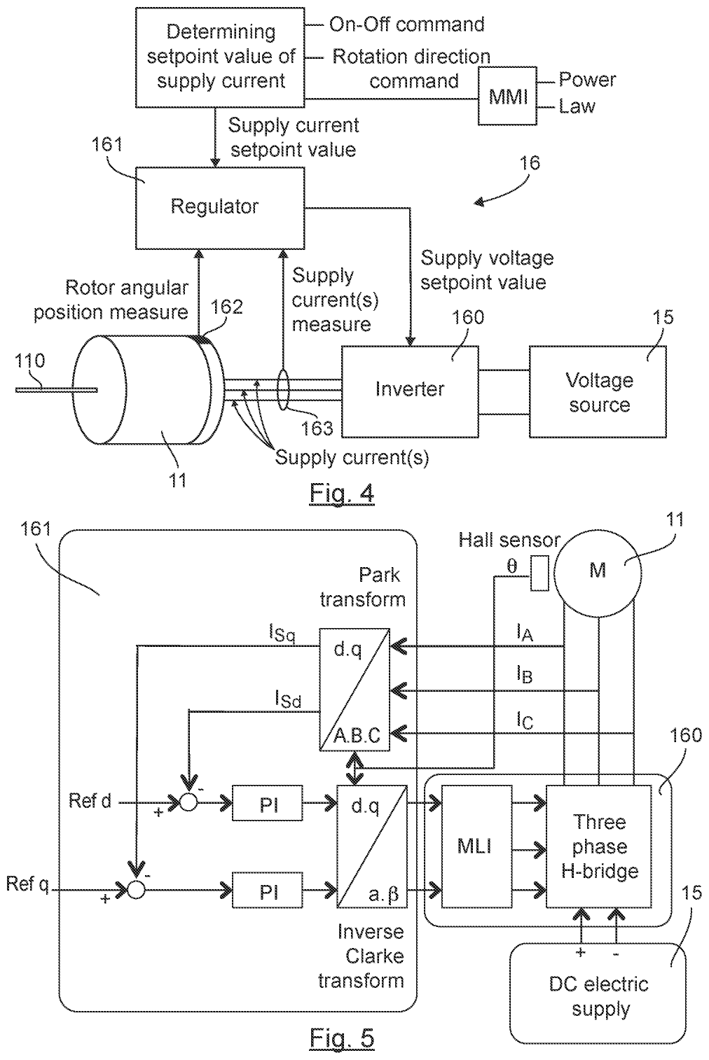

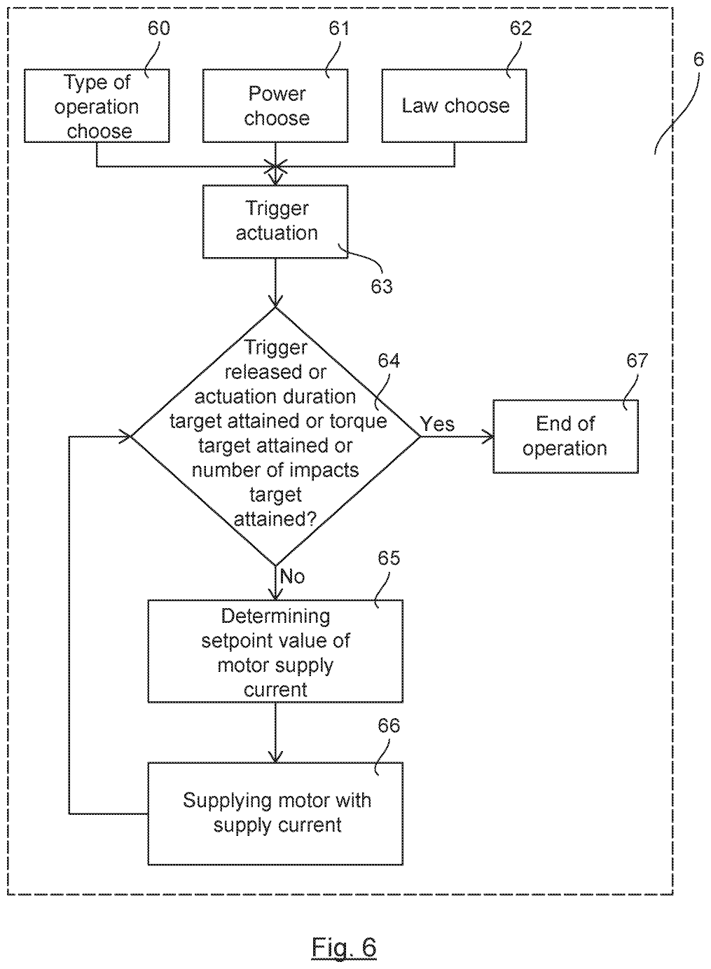

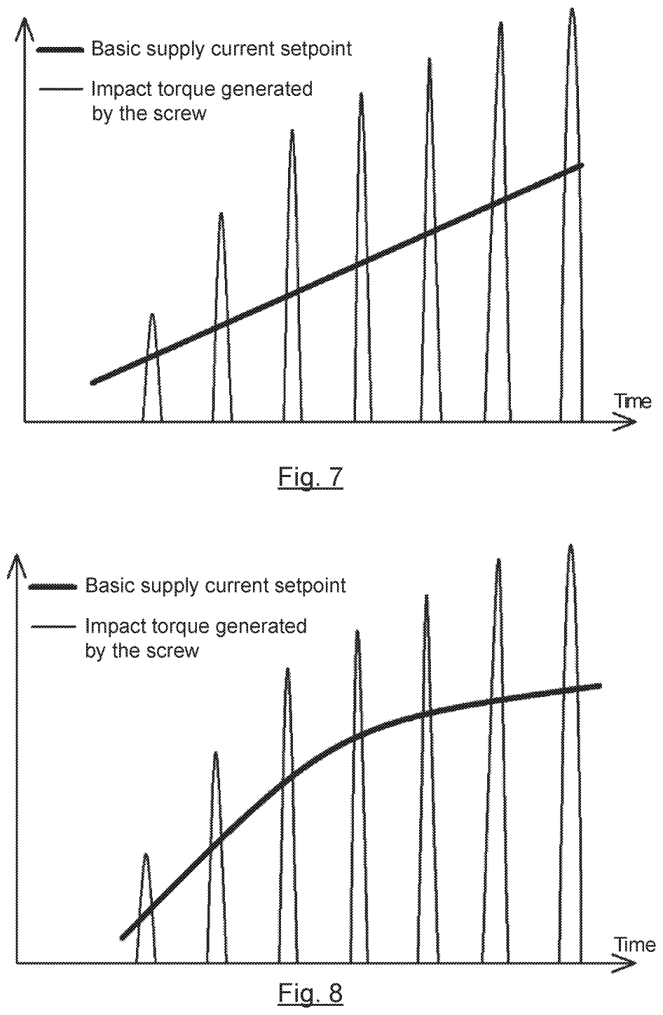

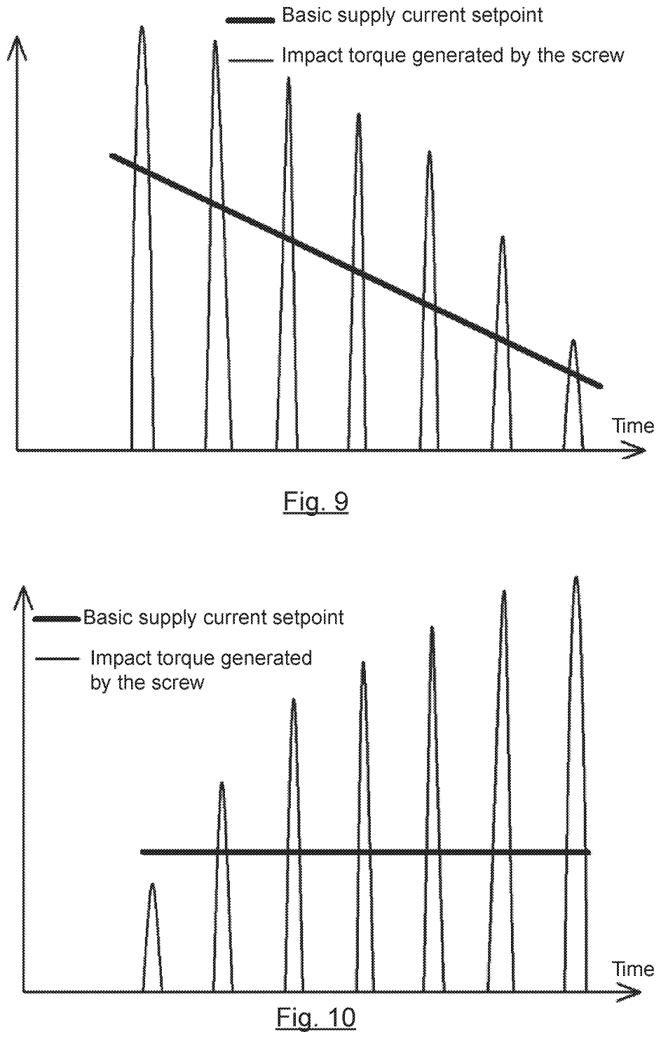

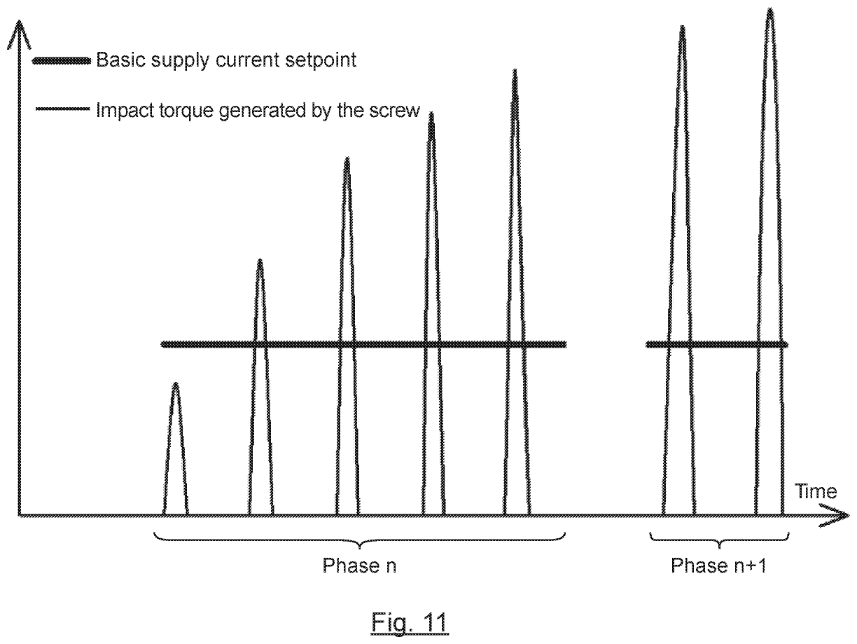

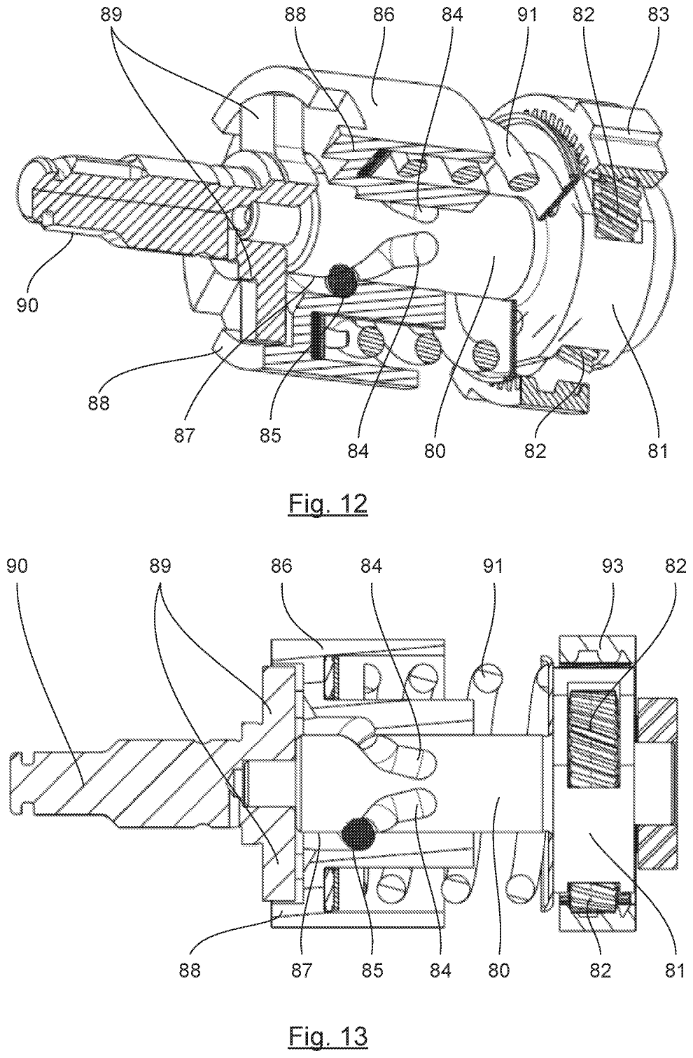

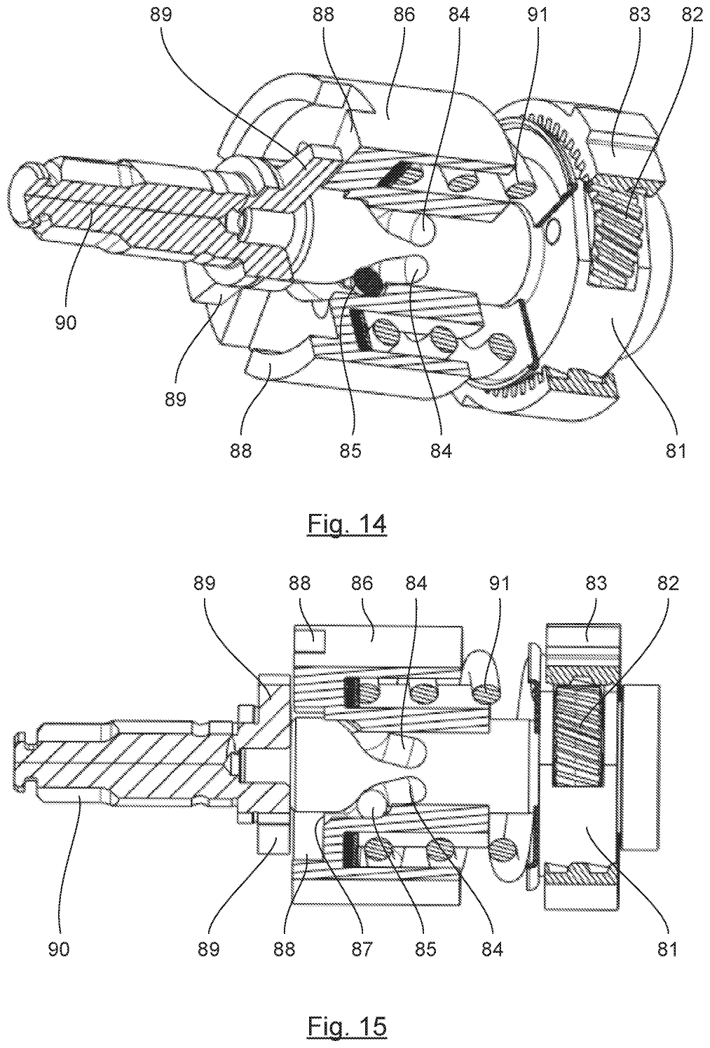

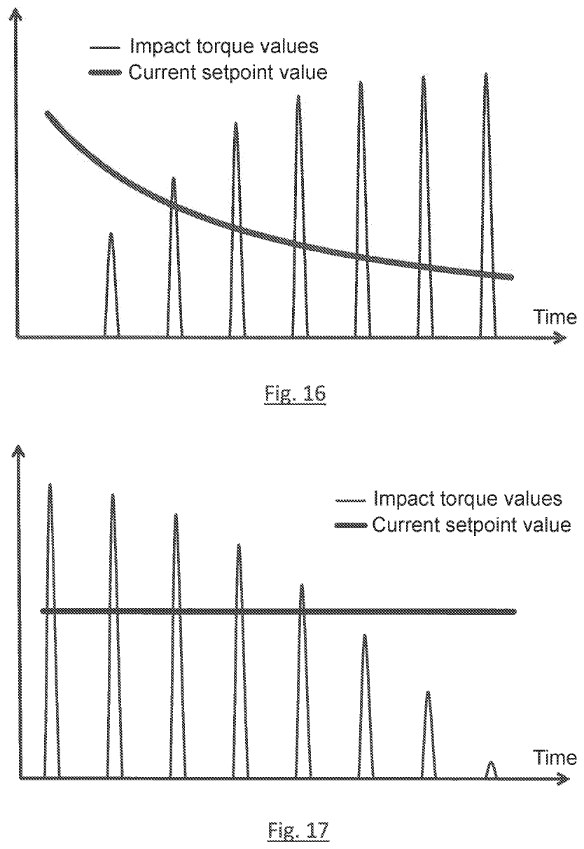

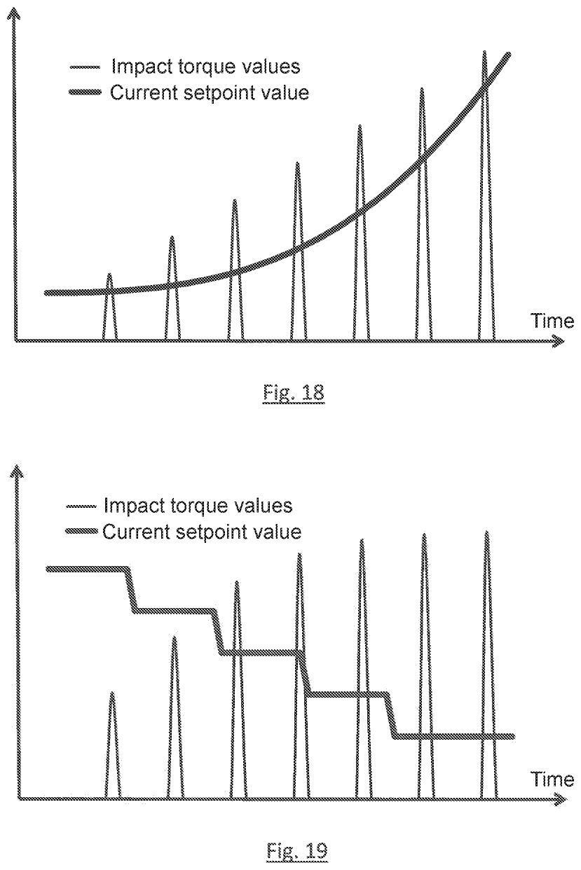

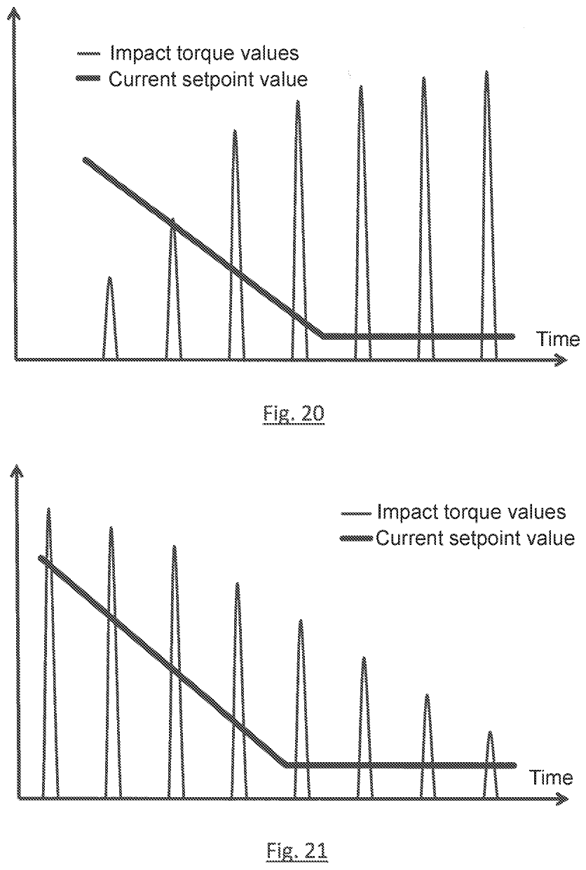

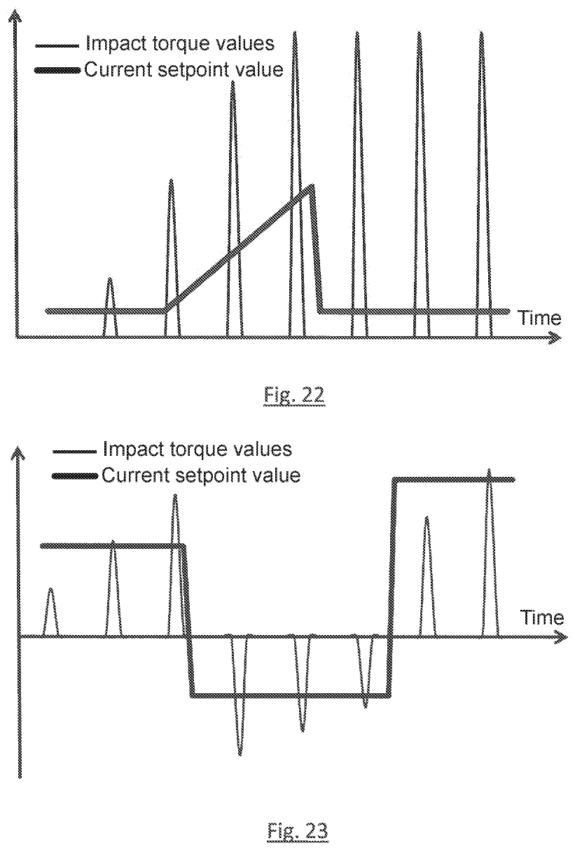

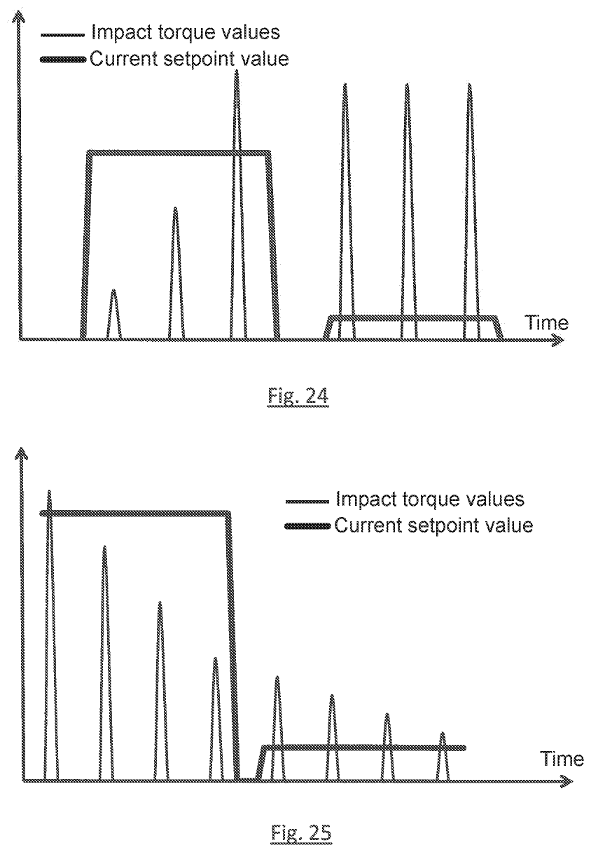

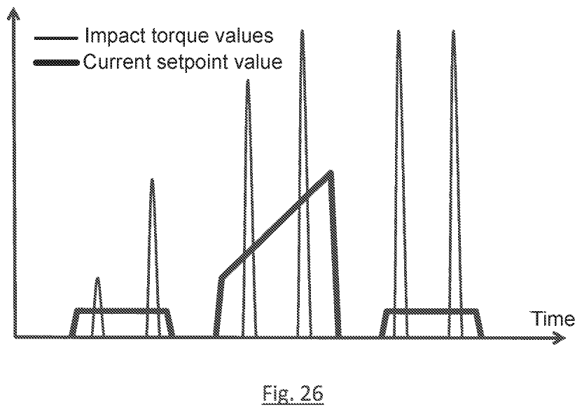

Referring to FIGS. 1 to 5, we present an example of an impact wrench 1 according to an exemplary embodiment.

Such an impact wrench 1 comprises a casing 10 housing an electric motor 11, an impact mechanism 12 and a rotating output element 13 designed to cooperate with a screwing/unscrewing bushing. The impact wrench comprises an actuating trigger 14.

The motor 11 comprises a rotor 111 and a stator 110. This is an electric motor. The motor may be of a permanent-magnet synchronous type. As an alternative, it could be any other type of electric motor, such as for example a DC motor, an asynchronous motor, a variable reluctance motor, a stepper motor, etc. It could be a mono-phase or multi-phase motor.

The rotor 111 is directly connected to the input of the impact mechanism 12. In other words, the transmission ratio between the rotor and the input of the impact mechanism 12 is equal to 1.

The impact mechanism 12 is of the rebound type. As shall appear more clearly here below, it is a rebound impact mechanism of a Maurer type. It could however be any other type of rebound impact mechanism such as for example and non-exhaustively:

single dog;

rocking dog;

two-jaw;

pin clutch;

hydraulic block;

etc.

The impact mechanism 12 comprises a mobile cage 120 that is mobile in rotation, directly engaged with the rotor 111 with which it is rotationally linked. The cage 120 is hollowed out and houses two hammers 121 fixedly attached to the cage in a rotationally mobile way around axes appreciably parallel to the rotational axis of the bell by means of pins 122 fitted into holes 123 made for this purpose in the bell 120.

The impact mechanism 12 comprises an output square drive 124 extending partly into the interior of the hammers 121 and of the bell 120. The output square drive 124 is rotationally linked with the rotating output element 13.

Classically, the bell 120 rotationally driven directly by the motor 11 moves the hammers 121 which pivot about the pins 122 and simultaneously dash against the anvils linked to the square drive 124 to transmit the kinetic energy contained in the moving parts (rotor 111, cage 120, hammers 121) to the output square drive 124 in impacts and drive this output square in rotation. After having come into collision with the anvil, the hammers, the cage and the rotor rebound in reverse to the operation in progress. During this rebound, the hammers take a disengaged position in which the hammers are no longer facing the anvils. The hammers keep this position momentarily during the re-acceleration of the rotor in the direction of the operation. Thus, the hammers pass by the anvils without striking them, enabling the cage to accelerate in its rotational movement. After a given rotation (of the order of one turn in the configuration illustrated) of the cage, the hammers again come into collision with the anvils to transmit the kinetic energy of the moving parts to the output square drive. Such an operating principle is for example described in detail in U.S. Pat. No. 3,661,217.

This is therefore a rebound impact mechanism of the type with automatic disengagement of the hammers from the anvil during the rebound and at the start of the re-acceleration and then automatic re-engagement.

In general, a rebound impact mechanism comprises:
an inertia wheel (in this case the cage 120);
anvils (linked to the output square drive 124);
a mechanical connection device between the inertia wheel and the anvil (in this case the hammers 121).

The impact wrench comprises a battery 15 to power the motor 11 with electric current. In certain variants, it can happen that the impact wrench includes not the battery but a connection cable to the mains power supply or a connection cable to a controller itself linked to the mains supply. The mains supply could be for example a rectified ac distribution network. The battery, the controller or the mains supply constitutes a source of electric voltage.

The impact wrench comprises control means 16 for the power supply to the motor 11. These control means 16 comprise means for regulating the supply current of the motor.

The control means 16 for the motor power supply are configured to deliver means for regulating an setpoint value of supply current inducing the generation, by the motor, of a predetermined electromagnetic torque.

More specifically, the means for controlling the power supply of the motor 16 comprise:

means for determining a setpoint value of supply current in real time;

the means for regulating the supply current of the motor.

These means for regulating the supply current of the motor comprise:
a regulator receiving the setpoint value of supply current coming from the determining means and expressing it in a setpoint value of supply voltage;
an inverter receiving the setpoint value of supply voltage and supplying the motor, as a function of this setpoint value, with a supply current for the motor.

The regulation means ensure that the power supply current of the motor is as close as possible to the setpoint value of supply current.

In other words, the means 16 for controlling the power supply of the motor 11 are configured to deliver a setpoint value of supply current to the regulator during a screwing or unscrewing operation on the basis of which the regulator transmits an setpoint value of supply voltage to the inverter. On the basis of this setpoint value of supply voltage, the inverter supplies the motor with a supply current inducing the generation by the motor of a predetermined electromagnetic torque proportional to the setpoint value of supply current. The setpoint value of supply current inducing the generation, by said motor, of an electromagnetic torque is predetermined as a function of time, for example.

The control means 16 for controlling the supply to the motor are herein configured to deliver to the regulator, during a screwing or unscrewing operation, a setpoint value of supply current inducing the generation, by the motor, of an electromagnetic torque evolving according to different laws.

The laws represented in FIGS. 7 to 11 represent the evolution, as a function of time, of a basic setpoint value of the supply current inducing the electromagnetic torque of the motor.

Since the electromagnetic torque of the motor is proportional to the supply current inducing said electromagnetic torque, the form of this law is representative of the variation as a function of the time desired for the electromagnetic torque of the motor during a screwing or unscrewing operation.

These laws expressing said basic setpoint value of the supply current are established as follows:
the evolution of the electromagnetic torque as a function of time is determined experimentally to obtain an optimum progression of the screwing or unscrewing operation, then on this basis,
with the coefficient of proportionality between the electromagnetic torque and the supply current being known, the evolution as a function of time of the supply current is computed,
it thus directly ensues the law representing the setpoint value of power supply current, which is the image of said desired current,
a range of multiplier coefficients applicable to this basic setpoint value is chosen in order to modulate the screwing or unscrewing power as a function of the user's wishes.

The coefficient of proportionality between the electromagnetic torque and the power supply current inducing said torque depends on the design parameters of the motor and can be measured experimentally.

The means for determining the setpoint value of supply current are configured to determine, in real time, the setpoint value of supply current generating the electromagnetic torque as a function of:
the direction of the operation: screwing or unscrewing;
the law selected by the user expressed as a variation in time of a basic setpoint value of the power supply current generating the electromagnetic torque;
as the case may be, the power of the impact wrench selected by the user.

The means for determining the setpoint value of supply current may for example classically comprise a microprocessor or a programmable controller associated with one or more memories and able to execute a program designed to determine the setpoint value of supply current. Any other structures or equivalent means can be implemented to this end.

The direction of the operation determines the sign of the setpoint value of the supply current generating the electromagnetic torque. For example, it is positive for a desired torque in the clockwise direction and negative for a desired torque in the anticlockwise direction.

For a given law, the choice of the power level leads to the application of a multiplier coefficient to the basic setpoint value of supply current corresponding to the chosen law.

A setpoint value of supply current generating the electromagnetic torque is therefore computed in real time as follows:
pressure on the trigger activates a measurement of the time,
on the basis of a predetermined frequency, the basic setpoint value of the supply current is read for the chosen law,
this value is, if necessary, multiplied by the coefficient resulting from the level of power chosen,
a sign is assigned to the previously obtained value according to the nature of the operation (screwing or unscrewing).

Thus, on the basis of said frequency, a setpoint value of power supply current is computed and given to the regulator in real time.

Certain laws are illustrated in FIGS. 7 to 11.

These figures illustrate:
in bold lines: the variation in the course of time of the basic setpoint value of supply current generating the electromagnetic torque of the motor, this setpoint value being proportional to the desired electromagnetic torque;
in fine lines: the variation in time of the torque generated by the impacts on the element to be screwed/unscrewed.

According to a first law, illustrated in FIG. 7, the setpoint value of supply current is configured to induce an evolution of the electromagnetic torque in rising order according to a predetermined linear function according to time throughout the screwing operation. The curves represented in this figure illustrate a screwing with increasing current. It is possible to have different laws of this type having different linear functions.

According to a second law illustrated in FIG. 8, the setpoint value of supply current is configured to induce an evolution of the electromagnetic torque increasing according to a predetermined polynomial function according to time throughout the screwing operation. The curves represented in this figure illustrate a screwing operation with a gradually increasing current to limit the reaction of the screwdriver when starting. It is possible to have different laws of this type having different polynomial functions.

According to a third law, illustrated in FIG. 9, the setpoint value of supply current is configured to induce an evolution of the electromagnetic torque decreasing according to a predetermined linear function predetermined as a function of time throughout the unscrewing operation. The curves shown in this figure illustrate an unscrewing operation with decreasing current. It is possible to have different laws of this type having different linear functions.

In one variant illustrated in FIG. 16, the setpoint value of supply current is configured to induce an evolution of the electromagnetic torque downwardly, according to a predetermined polynomial function according to time throughout the unscrewing operation. The curves represented in this figure illustrate a screwing operation with decreasing current to put a limit on the impact torque. It is possible to have different laws of this type having different polynomial functions.

According to a fourth law, illustrated in FIGS. 10 and 17, the setpoint value of supply current is configured to induce an electromagnetic torque that is constant throughout said screwing or unscrewing operation. The curves represented in FIG. 10 illustrate a screwing operation at constant current. The curves represented in FIG. 17 illustrate an unscrewing operation at constant current. It is possible to have different laws of this type having different linear functions.

According to another law illustrated in FIG. 18, the setpoint value of supply current is configured to induce an evolution of the electromagnetic torque increasing exponentially throughout a screwing operation. The curves represented in this FIG. 10 illustrate a current with exponential gradual increase to limit the reaction of the screwdriver when starting and to maintain a substantial increase in the electromagnetic torque between each impact. The setpoint value of supply current could be configured to induce an evolution of the electromagnetic torque that decreases exponentially throughout an unscrewing operation. It is possible to have different laws of this type having different exponential functions.

According to another law, illustrated in FIG. 19, the setpoint value of supply current is configured to induce an evolution of the electromagnetic torque that increases in stages throughout a screwing operation. This limits the final tightening torque. The setpoint value of supply current could be configured to induce an evolution of the electromagnetic torque by stages throughout an unscrewing operation. It is possible to have different laws of this type having different functions.

It is possible to implement a law that is the combination of several different laws. Examples of this type are mentioned here below with reference to FIGS. 20 to 23.

According to another law illustrated in FIG. 20, the setpoint value of supply current is configured to induce an evolution of the electromagnetic torque that decreases and is then constant throughout a screwing operation. This makes it possible to obtain a powerful and rapid screwing operation at the outset then subsequently an operation with limited power. It is possible to have different laws of this type having different functions.

According to another law illustrated in FIG. 21, the setpoint value of supply current is configured to induce an evolution of the electromagnetic torque that is decreasing and then constant throughout a screwing operation. This makes the drop in torque even. It is possible to have different laws of this type having different functions.

According to the law illustrated in FIG. 22, the setpoint value of supply current is configured to induce an evolution of the electromagnetic torque constantly and then increasingly and finally constantly throughout a screwing operation. This makes it possible obtain screwing with a low-power approach phase, a power value that then increases gradually and then falls back to prevent over-tightening.

According to the law illustrated in FIG. 23, the setpoint value of supply current is configured to induce an evolution of the electromagnetic torque constantly during a pre-screwing operation, then constantly during a partial unscrewing operation and finally constantly during a powerful final tightening operation.

These types of laws described further above concern screwing operations or unscrewing operations leading uninterruptedly to a succession of impacts until a target tightening torque is attained, each impact being represented in FIGS. 7 to 10 by a spike.

As an alternative, a screwing or unscrewing operation can comprise an interruption. In this case, this operation comprises three phases of predetermined durations: a first and a third phase, for example according to one of the preceding laws or a combination of several of these laws with one another separated by a second phase during which the power supply to the motor is interrupted. This is illustrated by the examples of FIGS. 11 and 24. This type of operation makes it possible to produce a usage familiar to operators in which, at the end of a screwing operation, a series of impacts on the screw is restarted to carry out a small screwing operation after the screwing proper to make sure that the tightening is correct.

This principle can be implemented in the context of a screwing operation as has just been illustrated. It can also be implemented in the context of an unscrewing operation as illustrated by way of an example in FIG. 25. This figure illustrates an unscrewing operation comprising a first unscrewing phase at constant current, a phase for interrupting the power supply to the motor and then an unscrewing phase at lower constant current. This gives a two-phase unscrewing operation which is powerful at the outset, then low-powered at the end, preventing the ejection of the screw.

A screwing or unscrewing operation could also include several interruptions, for example two or more interruptions. FIG. 26 illustrates for example a screwing operation comprises two interruptions. In this example, the setpoint value of supply current is configured to induce an evolution of the electromagnetic torque constantly, followed by a first interruption, followed by an evolution that increases linearly, followed by a second interruption, followed by a constant evolution of the electromagnetic torque. This makes it possible to obtain a screwing operation with a low-power approach followed by a screwing operation at increasing power and then a low-powered post-screwing operation.

It will be possible to record at least one law of at least one type in the memory associated with an impact wrench. The number of laws for different types cannot be equal.

Each law could be recorded in the form of a table of values associating a basic setpoint value of supply current with different instants.

As can be seen in FIGS. 7 to 11, before, during and after each impact, the motor delivers an electromagnetic torque including, during the impact, the rebound and the acceleration of the rotor. Thus, whatever the law implemented, the means to control the power supply of the motor are configured to power the motor in the direction of the working including during the rebound of the rebound impact mechanism. In other words, the motor is permanently powered so long as the trigger is actuated by the operator in charge of the operation or so long as the time elapsed since the actuation of the trigger has not attained a predetermined target duration or so long as the number of impacts in the impact mechanism has not attained a predetermined target number of impacts or so long as the tightening torque has not attained a predetermined target tightening torque. In other words, the target values are thresholds. The only interruption of power supply to the motor that can take place is the interruption between two successive phases of a screwing or unscrewing operation comprising several successive phases, and this can happen solely on the basis of predetermined durations.

The working direction is the screwing or unscrewing direction depending on whether the work is a screwing operation or an unscrewing operation.

As indicated further above, the means for controlling the power supply to the motor comprise means for regulating the power supply current of the motor. These means of regulation can classically comprise an inverter 160 powered by a source of DC voltage (battery 15, rectified mains), a regulator 161, a means 162 for measuring the angular position of the rotor relative to the stator, means 163 for measuring the current or currents exchanged between the motor 11 and the inverter 160, such as one or more current sensors. The current can be measured for example by shunt or by measurement of magnetic field or any other suitable technique.

The regulator 161 is configured to:
receive a predetermined setpoint value of power supply current, the signal representing the angular position of the rotor coming from means 162 for measuring the angular position of the rotor and the signal or signals coming from the means 163 for measuring current or currents exchanged between the inverter and the motor, and
compute a setpoint value of supply voltage and deliver it to an inverter 160 so that this inverter powers the motor with an electric supply current.

More specifically, the regulator 161 is configured to determine a setpoint value of supply voltage as a function of the setpoint value of power supply current. The regulator delivers this setpoint value of supply voltage to the inverter 160 in such a way that this inverter 160 powers the motor 11 with a supply current, the intensity of which is proportional to the predetermined setpoint value of supply current. The motor 11 thus delivers a predetermined electromagnetic torque proportional to the predetermined setpoint value of supply current while an operator is pressing the trigger 14 or does so long as the time elapsed since the actuation of the trigger has not attained a predetermined target duration or so long as the number of impacts in the impact mechanism has not attained a predetermined target number of impacts or so long as the tightening torque has not attained a predetermined target tightening torque.

An exemplary embodiment uses a vector type command applied to multi-phase permanent-magnet synchronous motors, this type of command being well known in the prior art.

This command makes it possible to drive the motor so that it produces an electromagnetic torque in real time proportional to a predetermined setpoint value of supply current.

The driving of a permanent-magnet synchronous motor requires knowledge of the angular position of the rotor relative to the stator in real time.

Different types of means 162 for measuring the angle of the rotor could be implemented.

These angle-measuring means could for example include a precise angle sensor (with a definition of less than 60 electrical degrees). This enables improved precision of angular placing of the current relative to the rotor of the motor. The electromagnetic torque is thus more stable and the efficiency of transformation of the electric power into mechanical power is optimal.

These angle measurement means could for example include angle sensors of the all-or-nothing Hall effect type. This solution simplifies the integration of the angle measurement means. The Hall effect sensors can directly measure the field of the magnets of the rotor. The impact on the rotating part of the motor is therefore very small. By contrast, the position of the current relative to the rotor is not optimal at any time, and the performance is therefore not as good as with a classic angle sensor.

The use of an algorithm associated with the Hall sensors is used to extrapolate the position of the rotor through the speed measured by timing the changes in state of the Hall sensors. This makes it possible for the angle measurement by Hall sensors to obtain a performance approaching that of more precise sensors.

These angle measurement means could for example determine the angular position of the rotor algorithmically from a mathematical model of the motor using only the currents resulting from a certain set of voltages applied to the motor. This angle measurement makes it possible to do without an angle sensor. This further simplifies the architecture of the tool. By contrast, the precision of the measurement depends on the speed. It does not always make it possible to obtain good performance.

Different command modes can be envisaged.

As mentioned further above, the control means 16 for controlling the motor power supply may use a vector type command. This command makes it possible, by means of mathematical transformations, to change a multi-phase system into a continuous system. It enables very efficient regulation of the electromotive torque produced by a synchronous motor.

FIG. 5 illustrates one example among others of a vector command according to which:
the boxes marked “PI” correspond to integral proportional correctors;
the Clarke, Park transforms and their inverse transforms are mathematical functions used to translate linear values into non-linear values and vice versa;
“Ref q” corresponds to the setpoint value of supply current generating torque in the motor. It is the current proportional to the electromotive torque;
“Ref d” corresponds to the setpoint value of flux-generating supply current. It is the current that makes it possible to modulate the magnetic flux of the motor and therefore to modulate the law between “Ref q” and the electromotive torque. This modulation leads to losses in the magnetic circuit of the motor. We therefore choose “Ref d”=0 in order to minimize the losses.

Since an exemplary embodiment is aimed at generating a predetermined electromotive torque, it relates very particularly to the regulation of the setpoint value of the supply current generating the electromagnetic torque.

The principle of a vector command of a motor is known per se to those skilled in the art and is therefore not described in greater detail herein.

Other means for controlling the power supply of the motor exist, for example a BLDC (Brushless DC) type command.

A command of this type powers only two phases of a three-phase motor. These two phases are selected relative to the state of the angular measurement Hall sensors. The voltage is then simply modulated to regulate the current that flows between these two phases. The architecture of the tool is then very simple. By contrast, the current cannot be placed at the ideal angle and the command is therefore not optimum.

Different modes of regulation can be envisaged.

The regulator 161 could integrate a well-known PID type corrector.

The regulator 161 could furthermore integrate an open-loop command in parallel with the PID corrector. This command, based on the model of the motor, enables faster command reactions during big variations in the parameters. This type of command is called a “feedforward” command which could also be described as pre-loading or forward command.

An “all-or-nothing” supply for the two active phases of a BLDC command is also possible. The power supply is continued until the current reaches a threshold, and then the power supply is stopped and restarted after a given time or after the current passes below a second threshold. This method produces a relatively stable average current. The structure of the regulation is very simple, but there is also a loss of performance.

The regulator could also integrate an MRC type corrector.

The modes of command and regulation of these types are known per se to those skilled in the art, with the special feature according to an exemplary embodiment of being implemented in order to drive the motor in current and not in speed as is the case in the prior art.

5.2. Functioning

An impact wrench according to an exemplary embodiment can be used by the operator to carry out a screwing/unscrewing method.

Such a step comprises a screwing/unscrewing step 6 during which the terminal element rotationally drives a bushing cooperating with an element to be screwed/unscrewed.

A screwing or unscrewing step corresponds to a screwing operation implemented:
for a duration assessed by the operator and terminated by a releasing of the trigger; this period can be predetermined, in which case the impact wrench comprises means to measure the time elapsed since the actuating of the trigger, the control means driving the stopping of the impact wrench automatically when this duration has elapsed, or
until the tightening torque attains a predetermined target torque value. In this case, the impact wrench can comprise means for measuring the torque generated by the impacts and comparing this torque with a target value of torque and stopping the impact wrench when the torque of the impact is greater than or equal to the target, or again
until a number of impacts has been generated. In this case, the impact wrench can include means for counting impacts and comparing this number with a target and for stopping the impact wrench when the number of impacts is greater than or equal to the target.

This screwing or unscrewing operation can include several successive phases (see FIG. 11) or not comprise them (see FIGS. 7 to 10).

The method comprises a step 60 for choosing the type of operation, i.e. the direction of rotation: screwing or unscrewing. This choice is made through a two-position button placed on the impact wrench.

The method comprises a step 61 for choosing the power value at which the operator wishes to carry out the screwing-unscrewing operation.

The method comprises a step 62 for choosing the law.

The choice of the power value and of the law is done through a man/machine interface (MMI) placed on the impact wrench. This interface can include a touchscreen (or an external device communicating with the impact wrench by radio waves or by wire links) enabling the user to move through the chosen menus.

To launch a screwing or unscrewing step 6, the operator actuates the trigger (step 63) and keeps it in the “on” position.

So long as the operator keeps the trigger in the “on” position or the target duration of actuation has not been reached or the target torque has not been attained or the target number of impacts has not been attained (step 64), the motor is powered on permanently and in the working direction (screwing or unscrewing according to the operation performed) including during the rebound of the impact system and therefore of the rotor. Should the screwing comprise several successive phases, it is possible for the motor not to be powered between two successive phases.

When the operator releases the trigger or when the target duration of actuation is attained or when the target torque is attained or when the target number of impacts is attained, the screwing-unscrewing operation ends (step 67).

The method comprises, during the screwing or unscrewing step 6, a step 65 for determining a setpoint value of supply current of the motor and a step 66 for powering the motor as a function of this setpoint value with a supply current, inducing the generation by the motor of a predetermined electromagnetic torque.

The setpoint value of supply current inducing the generation, by the motor, of an electromagnetic torque is predetermined as a function of the time and is determined as the function of the type of operation (screwing or unscrewing) and of the chosen power value and law.

The setpoint value of supply current is configured to induce an evolution of the predetermined electromagnetic torque according to one of the following power supply laws:
electromagnetic torque varying increasingly for a screwing operation following a predetermined linear function or polynomial function according to time throughout the step or varying decreasingly for an unscrewing operation,
electromagnetic torque that is constant throughout the screwing or unscrewing step,
screwing or unscrewing step comprising at least two phases of predetermined duration, the setpoint value of supply current being configured so that no electromagnetic torque is delivered by the motor between the at least two phases and being configured to induce an evolution of the predetermined electromagnetic torque according to one of the previous laws during phases.

More specifically, as soon as the operator presses on the trigger, the means for controlling the power supply to the motor compute the setpoint value of supply current in real time and at a predetermined frequency. This computation takes the following into account:
the type of operation: screwing or unscrewing
the value of the basic setpoint value of supply current that the chosen law proposes at the instant of determination. This instant is measured from the start of the pressure on the trigger.
the desired power: this level of power corresponds to a multiplier factor that is applied to the setpoint value of supply current defined by the power supply law.

The value of the setpoint value of supply current computed is provided in real time and at a predetermined frequency to the regulator 161. The regulator computes a setpoint value of supply voltage in real time, especially as a function of the setpoint value of supply current.

The regulator can also take account of other parameters to determine the setpoint value of the supply current of the motor such as for example the angular position of the rotor relative to the stator of the motor, the supply current or currents of the motor delivered by the inverter to the motor.

The setpoint value of supply voltage makes it possible to drive the inverter 160 so that it powers the motor with a supply current inducing the generation by the motor of a predetermined electromagnetic torque.

The regulator ensures that the current consumed by the motor is closer to the computed setpoint value of supply current and does so for the total duration of the screwing or unscrewing operation.

As has been said further above, the different types of commands envisaged, vector or BLDC commands are part of the prior art and their functioning is not described in greater detail.

Thus powered, the motor rotationally drives the impact mechanism which transmits successive torque pulses to the rotary terminal element to drive the screwing or unscrewing of the element to be tightened or loosened.

Following each torque pulse, the rotor rebounds in reverse to the work in progress according to the classic functioning of a rebound type impact mechanism. Since the motor is regulated in current and not in speed, the rebounds of the motor have no particular effect on the current consumed by the motor and are therefore not taken into consideration for its control.

As has just been explained, according to an exemplary embodiment, the motor is powered in the direction of the work being done (screwing direction if the operation carried out is a screwing operation, unscrewing direction if the operation carried out is an unscrewing operation). This is done permanently, throughout a screwing/unscrewing operation, i.e. including during the rebound of the rotor.

The motor is regulated not in speed but in predetermined intensity (i.e. in current) so that it delivers a predetermined electromagnetic torque.

Thus, during the rebound phases of the rotor, the regulation does not increase the intensity of the supply current to motor, since it is not necessary to cut off this supply unlike in the prior art.

As a consequence, the motor has a behavior close to that of a pneumatic motor which is permanently supplied with compressed air and therefore gives an appreciably constant torque.

A stable or progressive current (and therefore a stable or progressive electromagnetic torque) therefore sends a opposing stable or progressive torque back to the operator on the body of the tool, thus greatly reducing the vibrations experienced and improving the operator's comfort.

The technique according to an exemplary embodiment thus not only preserves the system by permanently powering the motor and preventing a rise in power supply intensity, but also improves the ergonomy of the impact wrench.

An exemplary embodiment of the disclosure is aimed especially at providing an efficient solution to at least some of these different problems.

In particular, an exemplary embodiment of the disclosure optimizes the electric impact wrenches integrating a rebound impact mechanism.

In particular, an exemplary embodiment of the disclosure provides an electric impact wrench integrating a rebound impact mechanism that is simple in design and/or simple to implement.

In particular, an exemplary embodiment of the disclosure provides an impact wrench of this kind that has a technique for regulating the motor that is simple and that efficiently preserves the integrity of the motor and of the control system.

At least one embodiment provides an impact wrench of this kind that is light and/or compact and/or induces a low level of vibrations as perceived by the user.

Although the present disclosure has been described with reference to one or more examples, workers skilled in the art will recognize that changes may be made in form and detail without departing from the scope of the disclosure and/or the appended claims.

1. An impact wrench comprising:
an electric motor comprising a rotor and a stator;
a rebound type impact mechanism;
a power supply controller configured to control a power supply of said motor, which comprises a current regulator to regulate a supply current of said motor;
said rotor of said motor being directly connected to said impact mechanism,
wherein the power supply controller of said motor is configured to deliver, to said current regulator, during a screwing or unscrewing operation, a setpoint value of supply current for the motor inducing generation, by said motor, of a predetermined electromagnetic torque,
and wherein the power supply controller of said motor is configured to supply said motor in a working direction including during a rebound of the rebound impact mechanism.

2. The impact wrench according to claim 1, wherein said setpoint value of the supply current inducing the generation, by said motor, of the predetermined electromagnetic torque is predetermined as a function of time.

3. The impact wrench according to claim 2, wherein said setpoint value of the supply current is configured to induce an evolution of said predetermined electromagnetic torque according to one or a combination of several of the following laws:
electromagnetic torque varying increasingly or decreasingly according to a predetermined linear or polynomial or exponential function according to time throughout said screwing or unscrewing operation,
electromagnetic torque that is constant throughout said screwing or unscrewing operation,
said screwing or unscrewing operation comprises at least two phases of predetermined durations, said setpoint value of power supply current being configured so that no electromagnetic torque is delivered by said motor between said at least two phases, this being the case for a predetermined duration, and being configured to induce an evolution of said predetermined electromagnetic torque according to one of the above laws during said phases.

4. The impact wrench according to claim 1, wherein said power supply controller of said motor comprise means for determining said setpoint value of supply current in real time.

5. The impact wrench according to claim 4 comprising a starting trigger and wherein said means for determining said setpoint value of supply current in real time comprise means for measuring the time elapsed since said starting trigger has been pressed.

6. The impact wrench according to claim 3, comprising means of selection, by the user, of:
the working direction of the impact wrench in screwing or unscrewing;
the law;
the power level.

7. The impact wrench according to claim 6 wherein said means for determining the supply current in real time use:
a measurement of the time elapsed since the trigger has been pressed;
the working direction selected by the user, screwing or unscrewing;
the law selected by the user;
the power level selected by the user.

8. A method of screwing/unscrewing by using an impact wrench with electric motor, comprising:
performing a screwing or unscrewing operation using the impact wrench, wherein the impact wrench comprises:
an electric motor comprising a rotor and a stator;
a rebound type impact mechanism;
a power supply controller configured to control a power supply of said motor, which comprises a current regulator to regulate a supply current of said motor;
said rotor of said motor being directly connected to said impact mechanism,
wherein the power supply controller of said motor is configured to deliver, to said current regulator, during the screwing or unscrewing operation, a setpoint value of supply current for the motor inducing generation, by said motor, of a predetermined electromagnetic torque,
and wherein the power supply controller of said motor is configured to supply said motor in a working direction including during a rebound of the rebound impact mechanism,
the screwing or unscrewing operation comprising delivery, to said current regulator, of the setpoint value of the supply current inducing the generation by said motor of the predetermined electromagnetic torque, said motor being powered in the working direction, including during the rebound of the rebound impact mechanism.

9. The method of screwing/unscrewing according to claim 8, wherein said setpoint value of supply current inducing the generation by said motor of the predetermined electromagnetic torque is predetermined as a function of time.

10. The method according to claim 9 wherein said setpoint value of supply current is configured to induce an evolution of said predetermined electromagnetic torque according to one or a combination of several of the following laws:
electromagnetic torque varying increasingly or decreasingly according to a predetermined linear or polynomial or exponential function according to time throughout said screwing or unscrewing operation,
electromagnetic torque constant throughout said screwing or unscrewing operation,
said screwing or unscrewing operation comprises at least two phases of predetermined durations, said setpoint value of supply current being configured so that no electromagnetic torque is delivered by said motor between said at least two phases, for a predetermined duration, and being configured to induce an evolution of said predetermined electromagnetic torque according to one of the preceding laws, during said phases.

11. The method according to claim 8, comprising determining said setpoint value of supply current in real time.

12. The method according to claim 8, comprising measuring time elapsed since a starting trigger of said impact wrench has been pressed.

13. The method according to claim 8, comprising selection by the user of:
the working direction of the impact wrench in screwing or unscrewing;
the law;
the power level.

14. The method according to claim 13, comprising:
measuring time elapsed since a starting trigger of said impact wrench has been pressed; and
determining said setpoint value of supply current in real time in taking account of:
the measurement of the time elapsed since the trigger has been pressed;
the type of work selected by the user, screwing or unscrewing;
the law selected by the user;
the power level selected by the use.
